(19) United States
(12) Patent Application Publication
(10) Pub. No.: US 2011/0237700 A1
(43) Pub. Date: Sep. 29, 2011

(54) PHOTOPOLYMERIZABLE POLYMER MICELLE, METHOD OF PRODUCING THE SAME, AND INK COMPOSITION CONTAINING PHOTOPOLYMERIZABLE POLYMER MICELLE

(75) Inventor: Toshiyuki Miyabayashi, Shiojiri-Shi (JP)

(73) Assignee: Seiko Epson Corporation, Tokyo (JP)

(21) Appl. No.: 13/070,781

(22) Filed: Mar. 24, 2011

(30) Foreign Application Priority Data
Mar. 24, 2010 (JP) 2010-068821

(51) Int. Cl. C09D 11/10; C08L 53/00

(52) U.S. Cl. 522/64

(57) ABSTRACT

A photopolymerizable polymer micelle includes a spherical micelle that encapsulates a hydrophobic photopolymerization initiator, the spherical micelle being formed by a block copolymer having a hydrophilic block segment and a hydrophobic block segment, the block copolymer having a number average molecular weight exceeding 10000, and the hydrophobic block segment at least partially having a radically polymerizable group.

### BACKGROUND

1. Technical Field

The present invention relates to a photopolymerizable polymer micelle, a method of producing the photopolymerizable polymer micelle, and a recording liquid containing the photopolymerizable polymer micelle. More specifically, the invention relates to a photocurable ink jet recording-targeted ink composition, photopolymerizable polymer micelle used for such an ink composition, and a method of forming such a micelle.

2. Related Art

In an ink jet printing technique, a droplet containing an ink composition is ejected and then adheres to a recording medium such as paper, thereby performing printing. The ink jet printing technique has an advantage in which an image with high resolution and high quality can be quickly printed.

Typically, in an ink composition that has been used in an ink jet recording technique, dye or pigment is used as a coloring material, and a water-soluble organic solvent or water is used as a primary component of a solvent. Such an ink composition is applied onto paper such as plain paper or fine paper or onto paper exclusively used for ink jet printing. An aqueous pigment ink does not contain a highly volatile solvent and is therefore advantageous in terms of safety and an impact on the environment. Unfortunately, in the case where the aqueous pigment ink is applied onto paper, such as fine paper or plain paper, into which ink is easily penetrated, ink bleeding is likely to occur resulting from the material type and structure of the paper, and sufficient print density is less likely to be provided. Furthermore, in such a case, the edge of a printed portion has decreased sharpness, and irregular color is likely to be caused. Therefore, the aqueous pigment ink cannot provide print quality that is provided by a typical printing technique such as letterpress. Furthermore, in the case where an ink jet recording-targeted water pigment ink is applied onto actual printing paper into which ink is less penetrated as compared with fine paper or plain paper, the solvent component of such an ink comes to be insufficiently dried, and it is therefore difficult to enable high-speed printing. Meanwhile, a metallic, ceramic, or plastic plate or film is employed as a recording medium, and an ink composition or a photocurable ink composition is used to perform ink jet printing, the ink composition containing dye and a nonaqueous solvent as an ink solvent, and the photocurable ink composition containing dye, a photocurable monomer, and a photo initiator. Some of the solvents and monomers to be used for such ink compositions have toxicity for animals and plants, and problems are still left in terms of safety and an impact on the environment, resulting from volatilization of such components.

Accordingly, even if printing is performed to a non-absorbable recording medium, an aqueous ink composition is preferably used in view of safety, an impact on the environment, and convenience in use. In the case where the aqueous ink composition is used for the printing to the non-absorbable recording medium, a coloring material is required to be strictly fixed (adhere) onto a surface of the recording medium, and short drying time, namely short fixing time, is required. In order to improve the fixing properties of the coloring material with respect to the recording medium, a suggestion has been made that the aqueous ink composition is used in combination with a resin having film-forming properties, and drying is performed by application of heat after printing has been completed. It is also suggested that a photopolymerization reaction, namely a process in which an ultraviolet curing reaction is utilized, is employed as a drying technique. An aqueous ink composition which contains dye, a water-soluble photopolymerizable monomer or oligomer, a water-soluble photo initiator, and water or which contains dye, water-soluble photopolymerizable polymer, a water-soluble photo initiator, and water is applied onto a non-absorbable recording medium. Then, a solvent such as water is dried, and ultraviolet light is radiated to cure the aqueous ink composition. However, the above types of inks may have inferior fixing properties with respect to a recording medium and may have inferior water resistance of coating.

International Publication Pamphlet No. WO 01/057145 discloses an aqueous ink that is in the form of emulsion and that contains a photopolymerizable resin in which a photo initiator and a monomer are encapsulated in an oligomer particle.

However, in the aqueous ink composition used for the ink jet recording technique, although the advantages such as safety and a reduced impact on the environment can be used, print quality that can be provided by plate printing still cannot be provided, such print quality including, for example, high print density, elimination of ink bleeding, the sharp edge of a printed portion, and elimination of irregular color. In addition, a recording that exhibits high print quality and sufficient fixing properties with respect to a metal, ceramic, or plastic material still cannot be produced, such a material not absorbing an aqueous ink.

If the oligomer particle disclosed in International Publication Pamphlet No. WO 01/057145 is used as a primary component of the ink jet recording-targeted ink composition, such oligomer particle is not necessarily sufficient in practical use, and there is therefore still room for improvement. The reason of such insufficiency is that the ink composition for which the oligomer particle is used is not necessarily sufficient in practical use in terms of preservation stability at normal temperature, preservation stability at high temperature (for example, a temperature range from 40 to 70° C.), and resistance to a solvent contained in the ink composition.

In the case where the oligomer particle disclosed in International Publication Pamphlet No. WO 01/057145 is contained in the ink composition in an increased amount, the viscosity of the ink composition is rapidly increased. Therefore, in the case where the oligomer particle is used in an ink jet recording technique, a disadvantage is caused, in which the oligomer particle has a serious impact on ink ejection. Furthermore, the oligomer particle disclosed in International Publication Pamphlet No. WO 01/057145 is particularly inadequate for application to a high-speed ink jet printer having an ultraviolet light-emitting mechanism in terms of photopolymerization properties.

### SUMMARY

An advantage of some aspects of the invention is that it provides a photopolymerizable polymer micelle, which has excellent photopolymerization properties, is free from the rapid increase of viscosity even in a high concentration region, exhibits preservation stability at normal temperature and high temperature, and exhibits excellent resistance to a solvent contained in an ink composition.

Another advantage of some aspects of the invention is that it provides an ink composition, which can provide print quality that can be provided by plate printing, can also provide high-quality printing with excellent fixing properties with respect to a non-absorbable recording medium, and has excellent safety and a reduced impact on the environment, the print quality including, for example, high print density, elimination of ink bleeding, the sharp edge of a printed portion, and elimination of irregular color.

In order to overcome the above disadvantages, the inventors have been intensely studied. In a continuous study, attention has been focused on the molecular structure of a micelle, and the inventors have found in the result that a micelle formed by a predetermined block copolymer, not oligomer, is significantly stable in structure. In addition, the inventors have found advantages, in which such a micelle exhibits excellent photo (radical) polymerization properties, is free from the rapid increase of viscosity even in a high concentration region, exhibits excellent preservation stability at normal temperature and high temperature (for example, temperature range from 40 to 70° C.), and exhibits excellent resistance to a solvent contained in an ink composition. Accordingly, the inventors have found that the above disadvantages can be overcome.

Furthermore, the inventors have found that the viscosity of an ink composition containing an amphiphilic compound which forms the micelle is increased in a high concentration area for the reason that the micelle formed by such an amphiphilic compound cannot keep the spherical shape thereof. Specifically, an amphiphilic compound that is contained in an aqueous liquid such as ink at a predetermined concentration forms a spherical micelle depending on its molecular structure. In the case where the concentration of the amphiphilic compound is further increased, it is considered that an aggregate is formed in the form of a plate or layer through the form of a bar or string, thereby increasing the viscosity of the aqueous liquid such as ink. Accordingly, the inventors have found that the spherical micelle formed by the amphiphilic compound keeps the spherical shape thereof even if an external stimulus is applied and that the viscosity of the aqueous liquid such as ink is therefore less likely to be increased even in a high concentration region of the amphiphilic compound.

Furthermore, in the case where the spherical micelle is changed into another aggregation structure with the result that a substance is encapsulated in the spherical micelle, a fear in which the encapsulated substance is leaked may be caused. Therefore, the inventors have found that the spherical micelle keeps the spherical shape thereof even if an external stimulus is applied, thereby being able to provide the above advantages.

The inventors have found that a predetermined block copolymer forms a (polymer) micelle in an aqueous solvent primarily containing water as a result of orienting a hydrophobic block segment having a radically polymerizable group at the core side and orienting a hydrophilic block segment having a hydrophilic group at the side of the aqueous solvent. The hydrophobic block segment is hereinafter referred to as “hydrophobic block”, and the hydrophilic block segment is referred to as “hydrophilic block”.

In such a predetermined block copolymer, a hydrophobic block into which a radically polymerizable group is introduced and a hydrophilic block are aligned in this order, or a hydrophobic block into which a radically polymerizable group is introduced, a hydrophobic block into which a radically polymerizable group is not introduced, and hydrophilic block are aligned in this order. The micelle is formed by the amphiphilic polymer and therefore has excellent resistance to an external stimulus as compared with a micelle that is formed by using a low-molecular-weight surfactant and amphiphilic oligomer. Specifically, such a micelle exhibits excellent preservation stability at normal temperature and high temperature (for example, temperature range from 40 to 70° C.), exhibits excellent resistance to a solvent contained in an ink composition, and is less likely to cause the rapid increase of viscosity even in a high concentration region.

In a reactive surfactant and urethane acrylate oligomer which are known as typical amphiphilic compounds having radically polymerizable groups and which have hydrophobic groups, hydrophilic groups, and radically polymerizable groups, the upper limitation on the number in which the radically polymerizable groups can be introduced is determined depending on molecular structures of the reactive surfactant and urethane acrylate oligomer. In general, although a radically polymerizable group is relatively easily introduced into the urethane acrylate oligomer than the reactive surfactant, the number is approximately limited to at most 10. In contrast, the copolymer of embodiments of the invention can have a plurality of radically polymerizable groups in the number greater than 10, and the inventors have therefore found that the copolymer of embodiments of the invention exhibits increased photo (radical) polymerization properties as compared with the typical amphiphilic reactive surfactant and urethane acrylate oligomer.

Furthermore, the inventors have found that radical photopolymerization reaction is accelerated in the case where a hydrophobic photopolymerization initiator is encapsulated in the (polymer) micelle that is formed by a block copolymer of embodiments of the invention in an aqueous solvent primarily containing water. Such an advantage is provided for the following reason: in the block copolymer of embodiments of the invention that forms the micelle, the hydrophobic block segment into which a radically polymerizable group is introduced is positioned at the side of the core of the micelle, and the hydrophobic photopolymerization initiator therefore is encapsulated in the core owing to hydrophobic interaction. Namely, the radically polymerizable group which is introduced into the hydrophobic block segment is adjacent to the hydrophobic photopolymerization initiator in the core of the micelle. Accordingly, in the case where ultraviolet light having a wavelength by which a cleavage reaction of the photopolymerization initiator is generated is emitted, an initiator radical that is generated as a result of cleavage of the photopolymerization initiator is radically polymerized with a plurality of adjacent radically polymerizable groups in the homogeneous field, namely the inside of the micelle. Therefore, a polymerization rate is significantly increased.

As described above, the inventors have found that a predetermined block copolymer forms a (polymer) micelle in an aqueous solvent primarily containing water as a result of orienting the hydrophobic block segment having a radically polymerizable group at the core side and orienting the hydrophilic block segment having a hydrophilic group at the side of the aqueous solvent. Therefore, the inventors have found that the disadvantages can be overcome, thereby completing the intense study for embodiments of the invention.

Specifically, embodiments of the invention provide the following advantages.

According to a first aspect of the invention, there is provided a photopolymerizable polymer micelle having a structure in which a hydrophobic photopolymerization initiator is encapsulated in a spherical micelle that is formed by a block copolymer having a hydrophilic block segment and a hydrophobic block segment, the block copolymer having a number average molecular weight exceeding 10000, and the hydrophobic block segment at least partially having a radically polymerizable group.

Preferably, a (a) block copolymer has a hydrophobic block segment into which a radically polymerizable group is introduced and has a hydrophilic block segment having a hydrophilic group, each being aligned in this order; a (b) block copolymer has a hydrophobic block segment into which a radically polymerizable group is introduced, a hydrophobic block segment having a hydrophobic group, and a hydrophilic block segment having a hydrophilic group, each being aligned in this order; and any one of the (a) block copolymer and the (b) block copolymer forms a micelle structure in an aqueous solvent primarily containing water, in which the hydrophobic block segment having the radically polymerizable group is oriented at the core side and in which the hydrophilic block segment having the hydrophilic group is oriented at the side of the aqueous solvent.

It is preferable that the hydrophilic block segment has one or more groups selected from the group consisting of a polyethylene oxide group, a carboxylate group, a sulfonate group, a phosphinic acid group, an amide group, and a hydroxyl group and that the hydrophobic block segment has one or more groups selected from the group consisting of an aliphatic hydrocarbon group, an aromatic hydrocarbon group, an alicyclic hydrocarbon group, a fluoroalkyl group, and a polysiloxane group and has a group having the radically polymerizable group at a terminal thereof.

It is preferable that the radically polymerizable group is one or more groups selected from the group consisting of an acryloyl group, a methacryloyl group, a vinyl group, and a vinyl ether group.

It is preferable that the hydrophobic photopolymerization initiator absorbs light that is in a wavelength range from 380 to 420 nm.

According to a second aspect of the invention, there is provided a method of producing a photopolymerizable polymer micelle, the method including: a first process of producing a solution in which a block copolymer is dissolved in water, the block copolymer having a hydrophilic block segment and a hydrophobic block segment and having a number average molecular weight exceeding 20000, and the hydrophobic block segment at least partially having a radically polymerizable group; a second process of forming a mixed solution as a result of adding a hydrophobic photopolymerization initiator to the resultant mixed solution and being mixed; and a third process of forming a micelle as a result of further adding water for emulsification, the micelle being formed by the block copolymer and encapsulating the hydrophobic photopolymerization initiator.

According to a third aspect of the invention, there is provided a recording liquid containing photopolymerizable polymer micelle having any of the above advantages.

### DESCRIPTION OF EXEMPLARY EMBODIMENTS

Embodiments of the invention will be hereinafter described in detail. Embodiments of the invention are not limited to the following embodiments and are variously modified within the scope of the invention.

### Photopolymerizable Polymer Micelle

A first embodiment of the invention provides a photopolymerizable polymer micelle. The photopolymerizable polymer micelle has a hydrophilic block segment and a hydrophobic block segment. A block copolymer forms the micelle in a spherical shape in an aqueous solvent primarily containing water, the block copolymer having a radically polymerizable group in at least part of a hydrophobic bloc segment and having a number average molecular weight exceeding 10000. The micelle encapsulates a hydrophobic photopolymerization initiator.

The term “monomer” herein refers to a monomer used for polymer synthesis and means a molecule having a molecular weight approximately less than or equal to 1000. The term “oligomer” herein refers to a low-polymerization-degree product that is produced from the monomer used for polymer synthesis and that has a repeating unit in the relatively small number and covers products from a dimer and trimer to one having a molecular weight of approximately thousands. A number average molecular weight used herein is obtained from dividing the total weight of polymers by the total number of molecules constituting the polymers and is measured by gel permeation chromatography (GPC).

The term “spherical shape” herein refers to a substantially spherical shape and an approximately spherical shape.

The photopolymerizable polymer micelle of the embodiment will be hereinafter described.

The above photopolymerizable polymer micelle refers to a micelle that is formed by a predetermined block copolymer in an aqueous solvent primarily containing water as a result of orienting a hydrophobic block at the core side and orienting a hydrophilic block at the side of the aqueous solvent, the hydrophobic block having a radically polymerizable group, and the hydrophilic block having a hydrophilic group. In the predetermined block copolymer, the hydrophobic block into which the radically polymerizable group is introduced and hydrophilic block having the hydrophilic group are aligned in this order. Alternatively, in a predetermined block copolymer, the hydrophobic block into which the radically polymerizable group is introduced, a hydrophobic block having a hydrophobic group, and the hydrophilic block having the hydrophilic group are aligned in this order.

The photopolymerizable polymer micelle of the embodiment can encapsulate an agent such as a photopolymerization initiator, and such an agent can be therefore held inside the core (inner shell) of the micelle.

In the embodiment, the aqueous solvent primarily containing water refers to a product that contains water as a primary solvent and that contains an organic solvent soluble in water, namely an aqueous organic solvent. Preferably, the water to be used is pure water, such as ion-exchanged water, ultrafiltrated water, reverse osmosis water, or distilled water or is ultrapure water.

As described above, the photopolymerizable polymer micelle is formed by the block copolymer. The term “block copolymer” refers to a copolymer in which two or more block segment structures are linked to each other on a polymer chain. The block copolymer of the embodiment is a polymer compound having one or more hydrophilic block segments and one or more hydrophobic block segments and has a radically polymerizable group in at least part of the hydrophobic block segment. Accordingly, the micelle of the embodiment can be referred to as a “polymer micelle”.

In the embodiment, the block copolymer may have a number average molecular weight exceeding 10000 in itself. In other words, each of the block segments that forms the block copolymer may have a number average molecular weight less than or equal to 10000.

The block copolymer of the embodiment has the above structure and therefore exhibits amphiphilic properties. The term “amphiphilic properties” herein refers to satisfying both the hydrophilic properties and hydrophobic properties. The term “hydrophilic properties” herein refers to properties that exhibit relatively large affinity with respect to an aqueous liquid primarily containing water. On the other hand, the term “hydrophobic properties” herein refers to properties that exhibit relatively small affinity with respect to the aqueous liquid.

The photopolymerizable polymer micelle provides an advantage in which the amphiphilic block copolymer encapsulates a polymerization initiator. In contrast, such an amphiphilic block copolymer is not contained in an ink disclosed in International Publication Pamphlet No. WO 01/057145, and therefore disadvantages are generated as described above.

The photopolymerizable polymer micelle of the embodiment can be used for a water-soluble recording liquid (hereinafter also referred to as “ink”), and such usage will be hereinafter described.

Examples of the alignment sequence of the block copolymer of the embodiment include an AB-type diblock, an ABC-type triblock, an ABA-type triblock, and an (AB)ₙ-type multiblock. Even if any of such alignment sequence is employed, in an aqueous solvent primarily containing water, the hydrophobic block segment is oriented at the core side, and the hydrophilic block segment having a hydrophilic group is oriented at the side of the aqueous solvent, thereby forming a micelle (polymer micelle). In this case, a configuration in which the radically polymerizable group is arranged at the side nearest the core has advantageous effect on the photo (radical) polymerization properties.

In an example of the alignment sequence, an AB-type diblock copolymer includes two block segments. The “A” segment is a hydrophilic block segment, and the “B” segment is a substantially hydrophobic block segment. The substantially hydrophobic block segment contains at least any one of a block segment produced through polymerization using a hydrophobic monomer as a constituent and a block segment that exhibits hydrophobic properties relative to the hydrophilic block segment.

In the embodiment, a configuration is employed, in which at least part of the hydrophobic block segment has a radically polymerizable group. As described above, in the embodiment, by virtue of the radically polymerizable group in such a configuration, radical polymerization reactivity can be enhanced.

Such enhancement is provided for the following reason: the hydrophobic photopolymerization initiator and the radically polymerizable group are configured so as to be arranged adjacent to each other owing to hydrophobic interaction and therefore easily react with each other, the hydrophobic photopolymerization initiator being encapsulated in the micelle, and the radically polymerizable group being included in the hydrophobic block segment provided inside the micelle.

Namely, in the micelle, the hydrophobic block segment, into which the radically polymerizable group is introduced, of the block copolymer that forms the micelle in the embodiment is positioned at the side of the core of the micelle, and therefore the hydrophobic photopolymerization initiator is encapsulated in the core owing to hydrophobic interaction. In this manner, the radically polymerizable group and the hydrophobic photopolymerization initiator are arranged adjacent to each other in the core of the micelle. In the case where ultraviolet light having a wavelength that causes the cleavage reaction of the photopolymerization initiator is radiated in the homogeneous field, namely the inside of the micelle, an initiator radical that is generated as a result of cleavage of the photopolymerization initiator is radically polymerized with a plurality of radically polymerizable groups of the adjacent hydrophobic block segment. Therefore, a polymerization rate is significantly increased.

As described above, in the block copolymer of the embodiment, the radically polymerizable group can be introduced in a much larger amount per a molecule as compared with a typical approach in which an oligomer such as polyurethane acrylate is used. Preferably, in the block copolymer that forms the micelle, 10% or more parts of the hydrophobic block segment have the radically polymerizable group, more preferably 50% or more.

The block copolymer that forms the micelle has a number average molecular weight exceeding 10000. In the case where the number average molecular weight is smaller than or equal to 10000, the micelle formed in the aqueous solvent primarily containing water may become unstable. Therefore, preservation stability at room temperature and high temperature (for example, a temperature range from 40 to 70° C.) may be decreased, and resistance to the solvent that serves as a component of the ink composition may be decreased. More preferably, the number average molecular weight is greater than 10000 and is smaller than or equal to 20000.

The micelle has a spherical shape as described above. Such a shape is employed for the following reason: the micelle is held at least in a spherical shape, so that the viscosity of the micelle can be effectively prevented from being increased even in a high concentration region. In other words, the block copolymer forms the micelle, thereby being able to produce a concentration-independent micelle, namely a micelle that is held in a spherical shape even in high concentration. Furthermore, the micelle has a spherical shape, and the photopolymerization initiator or the like encapsulated in the micelle is therefore prevented from being leaked from the micelle, thereby being able to keep high radical polymerization reactivity.

The micelle preferably has an average particle diameter smaller than 1 μm, more preferably smaller than or equal to 500 nm, and even more preferably in the range from 100 to 300 nm. In the case where the particle diameter falls within such a range, the encapsulated substance, such as the photopolymerization initiator, can be completely encapsulated. Therefore, an adverse effect such as increased viscosity is reduced, and in the case where an ink jet recording-targeted ink composition to which the micelle is applied is used, nozzle clogging is excluded. The average particle size herein referred is measured by a dynamic light scattering method or a laser diffraction-scattering method. For example, in the measurement though the dynamic light scattering method, a Zetasizer Nano which serves as an apparatus of measuring zeta potential and particle size and which is commercially available from Malvern Instruments Ltd can be employed. For example, in the measurement through the laser diffraction-scattering method, a Microtrac MT3000II commercially available from Microtrac Inc. can be employed.

The hydrophilic block segment has a hydrophilic group as part that exhibits hydrophilic properties, and examples of the hydrophilic group include a polyethylene oxide group, a carboxylate group and the salts thereof, a sulphonate group and the salts thereof, a phosphonate group and the salts thereof, an amide group, and a hydroxyl group. Among these hydrophilic groups, in terms of obtaining excellent hydrophilic properties, one or more groups selected from the group consisting of a polyethylene oxide group, a carboxylate group and the salts thereof, a sulphonate group and the salts thereof, and a phosphonate group and the salts thereof are preferably employed.

The hydrophilic block segment may have an aliphatic hydrocarbon group, an aromatic hydrocarbon group, or an alicyclic hydrocarbon group as long as the above group exists. The above hydrophilic group may be present on at least any one of the main chain and side chain of the hydrophilic block segment.

The hydrophobic block segment has a group as part that exhibits hydrophobic properties, and examples of such a group include, but are not limited to, an aliphatic hydrocarbon group, an aromatic hydrocarbon group, an alicyclic hydrocarbon group, a fluoroalkyl group, and a polysiloxane group in the structure thereof.

Examples of the aliphatic hydrocarbon group include, but are not limited to, an alkyl group, an alkenyl group, and an alkynyl group. Examples of the aromatic hydrocarbon group include, but are not limited to, an aryl group and an aralkyl group. Examples of the alicyclic hydrocarbon group include, but are not limited to, a cycloalkyl group. Specific embodiments of these groups include alkyl groups such as a methyl group, ethyl group, isopropyl group, isobutyl group, t-butyl group, and octyl group; aryl groups such as a phenyl group, naphthyl group, and biphenyl group; and aralkyl groups such as a benzyl group and phenethyl group.

Among these groups, in terms of securing sufficient hydrophobic properties, one or more groups selected from the group consisting of the aliphatic hydrocarbon group, the aromatic hydrocarbon group, the alicyclic hydrocarbon group, the fluoroalkyl group, and the polysiloxane group are preferably employed. More preferably, an aliphatic hydrocarbon group, an aromatic hydrocarbon group, an alicyclic hydrocarbon group, a fluoroalkyl group, and a polysiloxane group are employed, each having four or more carbon atoms. Even more preferably, a n-butyl group, an isobutyl group, a t-butyl group, a 2-ethyl hexyl group, an isodecyl group, a lauryl group, a stearyl group, an octyl group, an isooctyl group, a benzyl group, a cyclohexyl group, a phenyl group, a biphenyl group, a naphthyl group, an isobornyl group, a dicyclopentanyl group, a dicyclopentenyl group, a fluoroalkyl group, and a polysiloxane group are employed.

The above hydrophobic group may be present on at least any one of the main chain and side chain of the hydrophobic block segment.

In the embodiment, as described above, a radically polymerizable group is present in at least part of the hydrophobic block segment. In the embodiment, the block segments are aligned in the sequence described above.

The radically polymerizable group may be positioned at the terminal of the main chain in the hydrophobic block segment. In the case where such a block segment has a side chain, the radically polymerizable group may be positioned at the terminal of the side chain.

Examples of the radically polymerizable group include, but are not limited to, an acryloyl group, a methacryloyl group, an acrylamide group a methacrylamide group, an allyl group, a vinyl ether group, a vinyl thioether group, a vinyl amino group, and a vinyl group. Preferably, in terms of the particularly high radical photopolymerization reactivity, an acryloyl group, an acrylamide group, a methacryloyl group, or a methacrylamide group is employed. More preferably, an acryloyl group or acrylamide group is employed.

Although an example of the configuration and composition of an AB-type diblock copolymer will be described as follows, the embodiment is not limited to such an example at all. The structure represented by the formula (1) is an example of the AB-type diblock copolymer of the embodiment.

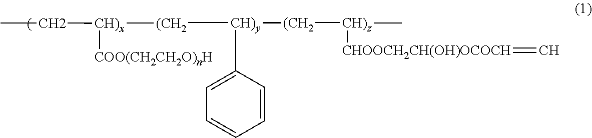

(in the formula, n, x, y, and z are each an independent integer)

In the formula (1), the hydrophilic block segment is represented by the formula (2), and the hydrophobic block segment is represented by the formula (3).

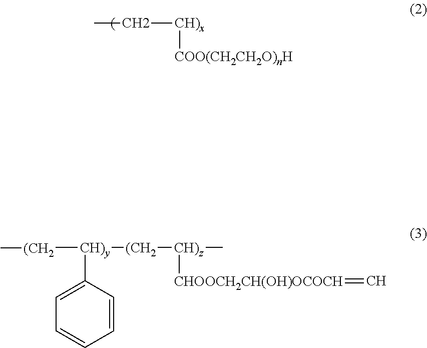

In the formula (2), the side chain is a polyethylene oxide group which functions as the part that exhibits hydrophilic properties.

In contrast, in the formula (3), an aromatic hydrocarbon group (benzyl group) and a group having a radically polymerizable group (acryloyl group) at the terminal thereof are linked to the main chain, the aromatic hydrocarbon group functioning as the part that exhibits hydrophobic properties.

Examples of a technique of synthesizing the block copolymer of the embodiment include a step-growth process and a coupling process. A living radical polymerization technique is preferably employed as the step-growth process. In the living radical polymerization technique, polymerization in which a nitroxyl radical such as a 2,2,6,6-tetramethyl-1-piperidinyloxy nitroxyl radical is used may be employed, or polymerization in which an exchange chain reaction with a reversible addition-fragmentation chain transfer agent such as a thiocarbonyl compound is utilized may be employed. In the coupling process, a coupling reaction between terminally reactive polymers is utilized. Accordingly, the AB-type block copolymer is produced from the combination of polymers that exhibit reactivity at one terminal thereof, the ABA-type block copolymer is produced from the combination of a polymer that exhibits reactivity at one terminal thereof and a polymer that exhibits reactivity at both terminals thereof, and (AB)ₙ-type multi-block copolymer is produced from the combination of a polymer that exhibits reactivity at both terminals thereof.

### Photopolymerization Initiator

The hydrophobic photopolymerization initiator is encapsulated in the photopolymerizable polymer micelle of the embodiment. Such a configuration is employed, and a polymerization rate in a radical polymerization reaction is therefore significantly increased as described above. In this case, “a hydrophobic photopolymerization initiator is encapsulated in the micelle” means that the hydrophobic photopolymerization initiator is held inside the core (inner shell) of the micelle.

For example, many types of the photopolymerization initiators are suggested in: Bruce M. Monroe et al. (1993). Chemical Revue. 93. 435; R. S. Davidson. (1993). Journal of Photochemistry and biology A. Chemistry. 73. 81; J. P. Faussier. (1998). “Photoinitiated Polymerization-Theory and Applications”. Rapra Review vol. 9. Report. Rapra Technology; and M. Tsunooka et al. (1996). Prog. Polym. Sci. 21. 1.

Specific examples of the hydrophobic photopolymerization initiator include, but are not limited to, acetophenone, 2,2-diethoxyacetophenone, p-dimethylaminoacetophenone, benzophenone, 2-chlorobenzophenone, p,p′-dichlorobenzophenone, p,p′-bisdiethylaminobenzophenone, Michler's ketone, benzyl, benzoin, benzoin methyl ether, benzoin ethyl ether, benzoin isopropyl ether, benzoin-n-propyl ether, benzoin isobutyl ether, benzoin-n-butyl ether, benzyl methyl ketal, 2,2-dimethoxy-1,2-diphenylethane-1-one, 1-hydroxycyclohexyl phenyl ketone, 2-hydroxy-1-{4-[4-(2-hydroxy-2-methylpropionyl)benzyl]phenyl}2-methylpropane-1-one, 2-benzyl-2-dimethylamino-1-(4-morpholinophenyl)butanone-1,2-dimethylamino-2-(4-methylbenzyl)-1-(4-morpholine-4-yl-phenyl)butane-1-one, 2,4,6-trimethyl benzoyl diphenyl phosphine oxide, bis(2,4,6-trimethyl benzoyl)phenyl phosphine oxide, bis(2,6-dimethoxybenzoyl)-2,4,4-trimethyl pentyl phosphine oxide, 2-methyl-1-[4-(methylthio)phenyl]2-morpholinopropane-1-one, thioxanthone, 2-chlorothioxanthone, 2-hydroxy-2-methyl-1-phenyl-1-one, 1-(4-isopropylphenyl)-2-hydroxy-2-methylpropane-1-one, methyl benzoyl formate, azobisisobutyronitrile, benzoyl peroxide, and di-t-butyl peroxide.

Especially, in the case where the photopolymerizable polymer micelle of the embodiment is used for a pigment ink, a photopolymerization initiator that exhibits absorbability with respect to ultraviolet light in a relatively large wavelength region is preferably used. Specifically, the hydrophobic photopolymerization initiator to be used in the embodiment absorbs light in a wavelength region that is preferably in the range from 380 to 420 nm. Accordingly, in the case where the photopolymerization initiator absorbs light in a wavelength region that fall within the above range, curing properties can be improved.

Examples of such a hydrophobic photopolymerization initiator preferably include acylphosphine oxide and specifically include 2,4,6-trimethylbenzoyl diphenylphosphine oxide, bis(2,4,6-trimethylbenzoyl)phenylphosphine oxide, and bis(2,6-dimethoxybenzoyl)-2,4,4-trimethylpentylphosphine oxide.

In commercially available products, examples of such a hydrophobic photopolymerization initiator include Darocur TPO and IRGACURE 819 (both are commercially available from Ciba Specialty Chemicals Inc.).

The photopolymerizable polymer micelle of the embodiment may contain a radically polymerizable hydrophobic monomer other than the above ingredients.

Specific examples of the radically polymerizable hydrophobic monomer include styrene derivatives such as styrene, methylstyrene, vinyltoluene, dimethylstyrene, chlorostyrene, dichlorostyrene, t-butylstyrene, bromostyrene and p-chloromethylstyrene; monofunctional acrylic esters such as methyl acrylate, ethyl acrylate, isopropyl acrylate, n-butyl acrylate, butoxyethyl acrylate, isobutyl acrylate, n-amyl acrylate, isoamyl acrylate, n-hexyl acrylate, octyl acrylate, decyl acrylate, dodecyl acrylate, octadecyl acrylate, benzyl acrylate, phenyl acrylate, phenoxyethyl acrylate, cyclohexyl acrylate, dicyclopentanyl acrylate, dicyclopentenyl acrylate, dicyclopentenyloxyethyl acrylate, tetrahydrofurfuryl acrylate, isobornyl acrylate, isoamyl acrylate, lauryl acrylate, stearyl acrylate, behenyl acrylate, ethoxydiethylene glycol acrylate, methoxytriethylene glycol acrylate, methoxydipropylene glycol acrylate, phenoxypolyethylene glycol acrylate, nonylphenol EO adduct acrylate, isooctyl acrylate, isomyristyl acrylate, isostearyl acrylate, 2-ethylhexyl diglycol acrylate, and octoxypolyethylene glycol polypropylene glycol monoacrylate; and monofunctional methacrylic esters such as methyl methacrylate, ethyl methacrylate, isopropyl methacrylate, n-butyl methacrylate, i-butyl methacrylate, t-butyl methacrylate, n-amyl methacrylate, isoamyl methacrylate, n-hexyl methacrylate, 2-ethylhexyl methacrylate, lauryl methacrylate, tridecyl methacrylate, stearyl methacrylate, isodecyl methacrylate, octyl methacrylate, decyl methacrylate, dodecyl methacrylate, octadecyl methacrylate, methoxydiethylene glycol methacrylate, polypropylene glycol monomethacrylate, benzyl methacrylate, phenyl methacrylate, phenoxyethyl methacrylate, cyclohexyl methacrylate, tetrahydrofurfuryl methacrylate, t-butylcyclohexyl methacrylate, behenyl methacrylate, dicyclopentanyl methacrylate, dicyclopentenyl methacrylate, dicyclopentenyloxyethyl methacrylate, butoxymethyl methacrylate, isobornyl methacrylate, and octoxypolyethylene glycol polypropylene glycol monomethacrylate.

Especially, in the case where a crosslinkable monomer having two or more unsaturated hydrocarbon groups that are selected from one or more of a vinyl group, an acryloyl group, a methacryloyl group, a propenyl group, a vinylidene group, and a vinylene group is used as the radically polymerizable hydrophobic monomer, such a monomer can further improve the photopolymerization properties of the photopolymerizable polymer micelle. In addition, a polymerized product (cured product) that exhibits toughness and excellent water, chemical, and thermal resistance can be obtained, and such a crosslinkable polymer is therefore preferably used. Specific examples of the crosslinkable polymer include ethylene glycol diacrylate, diethylene glycol diacrylate, triethylene glycol diacrylate, tetraethylene glycol diacrylate, polyethylene glycol diacrylate, allyl acrylate, bis(acryloxyethyl)hydroxyethyl isocyanurate, bis(acryloxyneopentyl glycol) adipate, 1,3-butylene glycol diacrylate, 1,6-hexanediol diacrylate, neopentyl glycol diacrylate, propylene glycol diacrylate, polypropylene glycol diacrylate, 2-hydroxy-1,3-diacryloxypropane, 2,2-bis[4-(acryloxy)phenyl]propane, 2,2-bis[4-(acryloxyethoxy)phenyl]propane, 2,2-bis[4-(acryloxyethoxy-diethoxy)phenyl]propane, 2,2-bis[4-(acryloxyethoxy-polyethoxy)phenyl]propane, hydroxypivalic acid neopentyl glycol diacrylate, 1,4-butanediol diacrylate, dicyclopentanyl diacrylate, dipentaerythritol hexaacrylate, dipentaerythritol monohydroxypentaacrylate, ditrimethylolpropane tetraacrylate, pentaerythritol triacrylate, tetrabromobisphenol A diacrylate, triglycerol diacrylate, trimethylolpropane triacrylate, tris(acryloxyethyl) isocyanurate, ethylene glycol dimethacrylate, diethylene glycol dimethacrylate, triethylene glycol dimethacrylate, tetraethylene glycol dimethacrylate, polyethylene glycol dimethacrylate, propylene glycol dimethacrylate, polypropylene glycol dimethacrylate, 1,3-butylene glycol dimethacrylate, 1,4-butanediol dimethacrylate, 1,6-hexanediol dimethacrylate, neopentyl glycol dimethacrylate, 2-hydroxy-1,3-dimethacryloxypropane, 2,2-bis[4-(methacryloxy)phenyl]propane, 2,2-bis[4-(methacryloxyethoxy)phenyl]propane, 2,2-bis[4-(methacryloxyethoxydiethoxy)phenyl]propane, 2,2-bis[4-(methacryloxyethoxypolyethoxy)phenyl]propane, tetrabromobisphenol A dimethacrylate, dicyclopentanyl dimethacrylate, dipentaerythritol hexamethacrylate, glycerol dimethacrylate, hydroxypivalic acid neopentyl glycol dimethacrylate, dipentaerythritol monohydroxypentamethacrylate, ditrimethylolpropane tetramethacrylate, pentaerythritol trimethacrylate, pentaerythritol tetramethacrylate, triglycerol dimethacrylate, trimethylolpropane trimethacrylate, tris(methacryloxyethyl) isocyanurate, allyl methacrylate, divinylbenzene, diallyl phthalate, diallyl terephthalate, diallyl isophthalate, and diethylene glycol bisallylcarbonate.

As described above, according to the embodiment, the photopolymerizable polymer micelle is provided, which has excellent photo (radical) polymerization properties, is free from the rapid increase of viscosity even in a high concentration region, exhibits preservation stability at normal temperature and high temperature, and exhibits excellent resistance to a solvent contained in an ink composition.

### Method of Producing Photopolymerizable Polymer Micelle

A second embodiment of the invention provides a method of producing a photopolymerizable polymer micelle. The method at least includes the following three processes. In the first process, a block copolymer having a hydrophilic block segment and a hydrophobic block segment is mixed with water, the hydrophobic block segment at least partially having radically polymerizable group. In the second process, a hydrophobic photopolymerization initiator is added to the mixed solution produced through the first process and is then mixed. In the third process, water is further added to the mixed solution produced through the second process to promote emulsification. Through the first to third processes, the micelle which is formed by the block copolymer having a number average molecular weight exceeding 10000 and which encapsulates the hydrophobic photopolymerization initiator can be formed.

The production method according to the embodiment will be hereinafter described. The same description as made in the first embodiment is omitted to avoid overlapping description.

### First Process

In the first process, a predetermined block copolymer is mixed with water. Preferably, the water to be used is pure water, such as ion-exchanged water, ultrafiltrated water, reverse osmosis water, or distilled water or is ultrapure water. The water has a temperature that is preferably in the range from 20 to 60° C., more preferably in the range from 30 to 50° C.

### Second Process

In the second process, a hydrophobic photopolymerization initiator is added to the mixed solution produced through the first process and is then mixed. The hydrophobic photopolymerization initiator is added in an amount that is in the range from 1 to 10 weight % relative to the weight of the block copolymer.

### Third Process

In the third process, water is further added to the mixed solution produced through the second process to promote emulsification. The same type of water as described in the first process is employed. The water has a temperature that is preferably in the range from 20 to 60° C., more preferably in the range from 30 to 50° C. Temperature that fall within the above range contributes to providing a good emulsified state.

The emulsification is promoted by using a common agitator. The agitation is preferably performed at a temperature that is in the range from 30 to 50° C. The agitation is preferably performed at a rate that is in the range from 100 to 500 rpm. The agitation is preferably performed for a time period that is in the range from one to five hours.

The third process has been completed, and then the photopolymerizable polymer micelle which is formed by the block copolymer having a number average molecular weight exceeding 10000 and which encapsulates the hydrophobic photopolymerization initiator can be formed.

### Recording Liquid

A third embodiment of the invention provides a recording liquid containing the photopolymerizable polymer micelle of the first embodiment. The recording liquid is used in ink jet recording, namely ink jet printing. In the ink jet printing, the recording liquid is heated or pressurized to be ejected in the form of a droplet, and the ejected droplet adheres to a recording medium such as paper, thereby performing recording.

The recording liquid contains pigment, the photopolymerizable polymer micelle, water, and a water-soluble organic solvent, the pigment functioning as a coloring material (recording agent). Furthermore, various types of additives may be contained in the recording liquid.

The photopolymerizable polymer micelle of the embodiment exhibits excellent photo (radical) polymerization properties, is free from the rapid increase of viscosity even in a high concentration region, exhibits excellent preservation stability at normal temperature and high temperature (for example, temperature range from 40 to 70° C.), and also exhibits excellent resistance to a solvent contained in an ink composition. Therefore, in the case where an ink jet recording-targeted ink composition in which the photopolymerizable polymer micelle is used is applied onto plain paper, fine paper, or actual printing paper, such an ink composition can provide high print density and does not cause ink bleeding. Accordingly, usage of such an ink composition provides the following advantages: the edge of a printed portion has sharp finish; print mottle is not caused; image quality exceeding print quality that is provided by plate printing can be provided; and a printed article that exhibits high image quality and sufficient fixing properties can be provided even in printing onto a non-absorbable material into which ink is not absorbed. In addition, such an ink composition has safety and a reduced impact on the environment as compared with organic inks and ultraviolet (UV) inks primarily containing monomers. Meanwhile, the term “fine paper” refers to high-quality printing paper in plain paper.

The term “plain paper” refers to paper (non-coated paper) having a surface which is not coated with pigment or the like. On the basis of a proportion of chemical pulp to be used, the plain paper is classified into high-quality printing paper (100%, fine paper), middle-quality printing paper (40% or higher and less than 100%, medium-quality paper and high quality groundwood paper), and low-quality printing paper (less than 40%, groundwood paper). Thin paper such as India paper used for, for example, the main body of a dictionary is included in the plain paper.

The term “actual printing paper” refers to printing paper (coated paper) which is produced by using high-quality printing paper or middle-quality printing paper as base paper and which has a surface onto which a coating material is applied. On the basis of the amount of the coating material, the actual printing paper is classified into art paper, coated paper, lightweight coated paper, and the like.

The other component than the photopolymerizable polymer micelle contained in the ink composition of the embodiment will be described.

The pigment is not specifically limited, and any of inorganic and organic pigments may be used as the pigment. Examples of the inorganic pigment include, in addition to titanium oxide and iron oxide, carbon blacks produced by known processes such as contact, furnace, and thermal processes. Examples of the organic pigment include azo pigments (such as azo lake, insoluble azo, condensed azo, and chelate azo pigments), phthalocyanine pigments (such as copper phthalocyanine and metal-free phthalocyanine pigments), condensed polycyclic pigments (such as anthraquinone, perylene, perinone, quinacridone, dioxazine, thioindigo, isoindolinone, and quinophthalone pigments), dye-type chelate pigments (such as basic dye-type chelate and acid dye-type chelate pigments), nitro pigments, nitroso pigments, and aniline black. The pigment preferably has an average particle size less than or equal to 10 μm, more preferably, less than or equal to 0.1 μm. The average thickness is herein measured by a dynamic light scattering method.

Examples of carbon black to be used for black ink include carbon blacks commercially available from Mitsubishi Chemical Corporation (for example, No. 2300, No. 900, MCF88, No. 33, No. 40, No. 45, No. 52, MA7, MA8, MA100, and No. 2200B); carbon blacks commercially available from Columbian Carbon Co., Ltd. (for example, Raven 5750, Raven 5250, Raven 5000, Raven 3500, Raven 1255, and Raven 700); carbon blacks commercially available from Cabot JAPAN K.K. (for example, Regal 400R, Regal 330R, Regal 660R, Mogul L, Monarch 700, Monarch 800, Monarch 880, Monarch 900, Monarch 1000, Monarch 1100, Monarch 1300, and Monarch 1400); and carbon blacks commercially available from Degussa (for example, Color Black FW1, Color Black FW2, Color Black FW2V, Color Black FW18, Color Black FW200, Color Black S150, Color Black S160, Color Black S170, Printex 35, Printex U, Printex V, Printex 140U, Special Black 6, Special Black 5, Special Black 4A, and Special Black 4).

Examples of pigment to be used for yellow ink include C.I.Pigment Yellow 1, C.I.Pigment Yellow 2, C.I.Pigment Yellow 3, C.I.Pigment Yellow 12, C.I.Pigment Yellow 13, C.I.Pigment Yellow 14C, C.I.Pigment Yellow 16, C.I.Pigment Yellow 17, C.I.Pigment Yellow 73, C.I.Pigment Yellow 74, C.I.Pigment Yellow 75, C.I.Pigment Yellow 83, C.I.Pigment Yellow 93, C.I.Pigment Yellow 95, C.I.Pigment Yellow 97, C.I.Pigment Yellow 98, C.I.Pigment Yellow 114, C.I.Pigment Yellow 128, C.I.Pigment Yellow 129, C.I.Pigment Yellow 151, and C.I.Pigment Yellow 154.

Examples of pigment used for magenta ink include C.I.Pigment Red 5, C.I.Pigment Red 7, C.I.Pigment Red 12, C.I.Pigment Red 48 (Ca), C.I.Pigment Red 48 (Mn), C.I.Pigment Red 57 (Ca), C.I.Pigment Red 57:1, C.I.Pigment Red 112, C.I.Pigment Red 123, C.I.Pigment Red 168, C.I.Pigment Red 184, and C.I.Pigment Red 202.

Examples of pigment used for cyan ink include C.I.Pigment Blue 1, C.I.Pigment Blue 2, C.I.Pigment Blue 3, C.I.Pigment Blue 15:3, C.I.Pigment Blue 15:34, C.I.Pigment Blue 16, C.I.Pigment Blue 22, C.I.Pigment Blue 60, C.I.Vat Blue 4, and C.I.Vat Blue 60.

Pigment which can be dispersed in water without usage of a dispersant can be used (surface-treated pigment). The surface-treated pigment can be dispersed in water without usage of a dispersant as a result of being subjected to surface treatment in which a surface of the surface-treated pigment is linked to one or more functional groups selected from a carbonyl group, a carboxyl group, a hydroxyl group, and a sulfone group or is linked to salts thereof. Specifically, for example, such a pigment is produced as a result of introducing a functional group or a molecule containing a functional group into a surface of a pigment particle, such as carbon black ink, through physical treatment such as vacuum plasma treatment or chemical treatment such as oxidation treatment using hypochlorous acid or sulfonic acid. A single type of or several types of functional groups may be introduced into one pigment particle. Types of the functional groups to be introduced and an introduction amount may be appropriately determined in view of dispersion stability in ink, color density, and drying properties entirely in an ink jet head. In the embodiment, a state in which pigment is stably present in water without usage of a dispersant is also referred to as a dispersion state. For example, the pigment preferably used in the embodiment can be produced by a method disclosed in JP-A-8-3498.

The pigment is preferably added to the ink composition in the form of a pigment dispersion liquid prepared by dispersing the pigment in an aqueous medium with the aid of a dispersant. Examples of a dispersant to be used for the preparation of the pigment dispersion liquid include a dispersant such as a polymeric dispersant or a surfactant, which is commonly used in the preparation of a pigment dispersion liquid. It would be apparent to a person skilled in the art that the surfactant contained in the pigment dispersion liquid would also function as a surfactant for the ink composition.

Examples of a preferred polymeric dispersant include natural polymers, and specific examples thereof include: proteins such as glue, gelatin, casein, and albumin; natural rubbers such as gum arabic and tragacanth gum; glycosides such as saponin; alginic acid and alginic acid derivatives such as propylene glycol alginate, triethanolamine alginate, and ammonium alginate; and cellulose derivatives such as methylcellulose, carboxymethylcellulose, hydroxyethylcellulose, and ethylhydroxycellulose.

Examples of additionally preferred polymeric dispersants include synthetic polymers, and examples thereof include: polyvinyl alcohols; polyvinyl pyrrolidones; acrylic resins such as polyacrylic acid, acrylic acid/acrylonitrile copolymer, potassium acrylate/acrylonitrile copolymer, vinyl acetate/acrylate copolymer, and acrylic acid/acrylate copolymer; styrene/acryl resins such as styrene/acrylic acid copolymer, styrene/methacrylic acid copolymer, styrene/methacrylic acid/acrylate copolymer, styrene/α-methylstyrene/acrylic acid copolymer, and styrene/α-methylstyrene/acrylic acid/acrylate copolymer; styrene/maleic acid copolymer; styrene/maleic anhydride copolymer; vinylnaphthalene/acrylic acid copolymer; vinylnaphthalene/maleate copolymer; vinyl acetate copolymers such as vinyl acetate/ethylene copolymer, vinyl acetate/fatty acid vinylethylene copolymer, vinyl acetate/maleate copolymer, vinyl acetate/crotonic acid copolymer, and vinyl acetate/acrylic acid copolymer; and salts of the above polymers.

Among them, a copolymer of a monomer having a hydrophobic group with a monomer having a hydrophilic group in its molecular structure and a polymer of a monomer having both a hydrophobic group and a hydrophilic group in its molecular structure are especially preferred. For example, in the preparation of the pigment dispersion liquid used in the embodiment, pigment, a dispersant, and water or a mixture of water and a water-soluble organic solvent (for example, low-boiling-point organic solvent) are first mixed with each other. Then, the resultant product is dispersed by using a disperser (for example, a bead mill, a ball mill, a sand mill, an attritor, a roll mill, an agitator, a Henschel mixer, a colloid mill, an ultrasonic homogenizer, or a pearl mill), thereby being able to complete the preparation.

The pigment is contained in an amount that is in the range from 1 to 10 weight % relative to the total amount of the ink composition, more preferably in the range from 2 to 5 weight %.

Examples of the water, namely serving as primary solvent, to be used include pure water, such as ion-exchanged water, ultrafiltrated water, reverse osmosis water, or distilled water and include ultrapure water.

One or more polar solvents can be added to the ink composition of the embodiment, the one or more polar solvents being selected from the group consisting of 2-pyrrolidone, N-methylpyrrolidone, ε-caprolactam, dimethyl sulfoxide, sulfolane, morpholine, N-ethylmorpholine, and 1,3-dimethyl-2-imidazolidinone. Addition of the polar solvents provides an advantageous effect in which the dispersibility of a capsulated pigment particle contained in the ink composition is improved, thereby being able to improve stability in ink ejection.

The polar solvents are contained in an amount that is preferably in the range from 0.1 to 20 weight % relative to the total amount of the ink composition, more preferably in the range from 1 to 10 weight %.

Preferably, for the purpose of accelerating the penetration of the aqueous solvent into the recording medium, the ink composition of the embodiment further contains a penetrant. By virtue of prompt penetration of the aqueous solvent into the recording medium, a recording with a less blurred image can be obtained. As for such a penetrant, an alkyl ether of a polyhydric alcohol (also called glycol ethers) and/or a 1,2-alkyldiol is preferably used. Examples of the alkyl ether of a polyhydric alcohol include ethylene glycol monomethyl ether, ethylene glycol monoethyl ether, ethylene glycol monobutyl ether, ethylene glycol monomethyl ether acetate, diethylene glycol monomethyl ether, diethylene glycol monoethyl ether, ethylene glycol mono-n-propyl ether, ethylene glycol mono-iso-propyl ether, diethylene glycol mono-iso-propyl ether, ethylene glycol mono-n-butyl ether, diethylene glycol mono-n-butyl ether, triethylene glycol mono-n-butyl ether, ethylene glycol mono-t-butyl ether, diethylene glycol mono-t-butyl ether, 1-methyl-1-methoxybutanol, propylene glycol monomethyl ether, propylene glycol monoethyl ether, propylene glycol mono-t-butyl ether, propylene glycol mono-n-propyl ether, propylene glycol mono-iso-propyl ether, dipropylene glycol monomethyl ether, dipropylene glycol monoethyl ether, dipropylene glycol mono-n-propyl ether, dipropylene glycol mono-iso-propyl ether, propylene glycol mono-n-butyl ether, and dipropylene glycol mono-n-butyl ether. Examples of the 1,2-alkyldiol include 1,2-pentanediol and 1,2-hexanediol. Other examples include diols of a linear hydrocarbon such as 1,3-propanediol, 1,4-butanediol, 1,5-pentanediol, 1,6-hexanediol, 1,7-heptanediol, and 1,8-octanediol. An appropriate penetrant may be selected from these and used for the ink composition of the embodiment.

Particularly, one or more penetrants selected from propylene glycol monobutyl ether, dipropylene glycol monobutyl ether, diethylene glycol monobutyl ether, triethylene glycol monobutyl ether, 1,2-pentanediol, and 1,2-hexanediol are preferably used.

The penetrant content is preferably in the range from 1 to 20 weight % relative to the total amount of the ink composition, more preferably in the range from 1 to 10 weight %. In the case where the penetrant content is larger than or equal to 1 weight %, an advantageous effect of enhancing the penetrability of the ink composition into the recording medium is provided. In the case where the content is less than or equal to 20 weight %, generation of blurring on the image that is printed by using such an ink composition can be prevented, and the excessively increased viscosity of the ink composition can be suppressed.

Glycerin is contained in the ink composition of the embodiment, so that clogging of an ink jet nozzle during usage of the ink composition for ink jet recording becomes less likely to be generated, and the preservation stability of the ink composition itself may be also enhanced.

The ink composition of the embodiment preferably contains a surfactant, particularly an anionic surfactant and/or a nonionic surfactant. Specific examples of the anionic surfactant include, but are not limited to, alkanesulfonate, α-olefinsulfonate, alkylbenzenesulfonate, alkyl-naphthalenesulfonic acid, acylmethyltaurine acid, dialkylsulfosuccinic acid, alkyl sulfate, sulfated oil, sulfated olefin, polyoxyethylene alkyl ether sulfate, fatty acid salt, alkyl sarcosine salt, alkyl phosphate, polyoxyethylene alkyl ether phosphate, and monoglyceride phosphate. Specific examples of the nonionic surfactant include, but are not limited to, polyoxyethylene alkyl ether, polyoxyethylene alkyl phenyl ether, poly-oxyethylene alkyl ester, polyoxyethylene alkylamide, glycerin alkyl ester, sorbitan alkyl ester, sugar alkyl ester, polyhydric alcohol alkyl ether, and alkanolamine fatty acid amide.

Examples of the anionic surfactant include, but are not limited to, sodium dodecylbenzenesulfonate, sodium laurate, and an ammonium salt of polyoxyethylene alkyl ether sulfate. Examples of the nonionic surfactant include, but are not limited to, ether compounds such as polyoxyethylene nonyl phenyl ether, polyoxyethylene octyl phenyl ether, polyoxyethylene dodecyl phenyl ether, polyoxyethylene alkyl allyl ether, polyoxyethylene oleyl ether, polyoxyethylene lauryl ether, polyoxyethylene alkyl ether, and polyoxyalkylene alkyl ether; and ester compounds such as polyoxyethylene oleic acid, polyoxyethylene oleate, polyoxyethylene distearate, sorbitan laurate, sorbitan monostearate, sorbitan monooleate, sorbitan sesquioleate, polyoxyethylene monooleate, and polyoxyethylene stearate.

In particular, the ink composition of the embodiment preferably contains an acetylene glycol-based surfactant and/or acetylene alcohol-based surfactant as the surfactant. By virtue of such a surfactant, the aqueous solvent contained in the ink composition can easily penetrate into the recording medium, and a less blurred image can be therefore printed on various recording mediums. A commercially available product can be utilized as the acetylene glycol-based surfactant. Specific examples of such a surfactant include, but are not limited to, Surfynol 104, 82, 465, 485, 104PG50 and TG (all are product names, commercially available from Air Products and Chemicals, Inc.); and Olfine STG and Olfine E1010 (both are product names, commercially available from Nissin Chemical Industry Co., Ltd.). Examples of the acetylene alcohol-based surfactant include, but are not limited to, Surfynol 61 (product name, commercially available from Air Products and Chemicals, Inc.).

Such an acetylene glycol-based surfactant and/or acetylene alcohol-based surfactant is used in an amount that is preferably in the range from 0.01 to 10 weight % relative to the total weight of the ink composition, more preferably in the range from 0.1 to 5 weight %.

The ink composition of the embodiment may contain a pH adjuster. Specific examples of the pH adjuster include alkali metal salts such as sodium hydroxide, potassium hydroxide, lithium hydroxide, sodium carbonate, sodium hydrogen carbonate, potassium carbonate, lithium carbonate, sodium phosphate, potassium phosphate, lithium phosphate, potassium dihydrogen phosphate, dipotassium hydrogen phosphate, sodium oxalate, potassium oxalate, lithium oxalate, sodium borate, sodium tetraborate, potassium hydrogen phthalate, and potassium hydrogen tartrate; ammonium; and amines such as methylamine, ethylamine, diethylamine, trimethylamine, triethylamine, tris(hydroxymethyl)aminomethane hydrochloride, triethanolamine, diethanolamine, diethylethanolamine, triisopropenolamine, butyldiethanolamine, morpholine, and propanolamine.

For the purpose of preventing fungus, putrefaction, or rust, one or more compounds selected from benzoic acid, dichlorophene, hexachlorophene, sorbic acid, p-hydroxybenzoate, ethylenediaminetetraacetic acid (EDTA), sodium dehydroacetate, 1,2-benthiazolin-3-one [product name: Proxel XL (commercially available from Avecia)], 3,4-isothiazolin-3-one, and 4,4-dimethyloxazolidine may be added to the ink composition of the embodiment.

Furthermore, for the purpose of preventing a nozzle of an ink jet recording head from being dried, one or more components selected from the group consisting of urea, thiourea, and ethylene urea may be also added to the ink composition of the embodiment.

The ink composition of the embodiment may further contain a wetting agent. Any wetting agent that is commonly used for a recording liquid can be used without limitation. Preferably, the wetting agent to be used has a high boiling point greater than or equal to 180° C., more preferably greater than or equal to 200° C. In the case where boiling point falls within such a range, water holding properties and wettability can be imparted to the recording liquid.

Specific examples of the high boiling point wetting agent include, but are not limited to, ethylene glycol, propylene glycol, diethylene glycol, triethylene glycol, pentamethylene glycol, trimethylene glycol, 2-butene-1,4-diol, 2-ethyl-1,3-hexanediol, 2-methyl-2,4-pentanediol, tripropylene glycol, polyethylene glycol having a number average molecular weight less than or equal to 2,000, 1,3-propylene glycol, isopropylene glycol, isobutylene glycol, glycerin, mesoerythritol, and pentaerythritol. These wetting agents may be used alone or in combination of two or more. By virtue of adding a high boiling point wetting agent to the ink composition, an ink jet recording-targeted pigment ink can be produced, which enables flowability and re-dispersibility to be maintained for a long time period even if the ink jet recording-targeted pigment ink is left in an open state (namely, a state in which the ink composition is in contact with air at room temperature). Furthermore, such a recording liquid is less likely to cause clogging of an ink jet nozzle during printing in an ink jet printer or at the restarting after interruption of printing, and an ink composition that exhibits high stability in ejection from an ink jet nozzle can be therefore produced. The wetting agent is contained in an amount that is preferably in the range from 1 to 15 weight % relative to the total amount of the ink composition, more preferably in the range from 2 to 10 weight %.

Preferably, the ink composition of the embodiment may contain sugar. Addition of sugar provides wettability. In particular, the addition of the sugar imparts an advantage to the ink composition, in which water-holding properties and wettability are maintained for a long period. Therefore, even if the ink composition is preserved for a long period, the agglutination of the pigment and increased viscosity are eliminated, and excellent preservation stability can be accordingly provided. Furthermore, by virtue of the addition of sugar, an advantage in which flowability and re-dispersibility can be maintained for a long period even if the ink composition is left in an open state (namely, a state in which the ink composition is in contact with air at room temperature) can be imparted to the ink composition. Moreover, the addition of sugar can prevent clogging of an ink jet nozzle during printing in an ink jet printer or at the restarting after interruption of printing. Accordingly, high stability in ink ejection can be provided. Specific examples of sugar include monosaccharides, disaccharides, oligosaccharides (including trisaccharides and tetrasaccharides), and polysaccharides. Among these sugars, preferred are glucose, mannose, fructose, ribose, xylose, arabinose, galactose, aldonic acid, glucitol, sorbit, maltose, cellobiose, lactose, sucrose, trehalose, and maltotriose. The term “polysaccharides” as used herein means sugar in its broad sense and is used as the meaning of including substances widely occurring in nature, such as alginic acid, α-cyclodextrin, and cellulose. Examples of the derivative of such sugars include a reducing sugar of the above-described sugar [for example, sugar alcohol represented by the formula: HOCH₂(CHOH)ₙCH₂OH (In the formula, n represents an integer of 2 to 5)], oxidized sugar (for example, aldonic acid or uronic acid), amino acid, and thiosugar. In particular, sugar alcohol is preferably employed, and specific examples thereof include maltitol and sorbitol. Such sugar is added in an amount that is preferably in the range from 0.1 to 40 weight %, more preferably in the range from 1 to 30 weight %.

### Physical Properties of Recording Liquid

Preferably, the recording liquid has a viscosity that is in the range from 3 to 30 mPa·s at a temperature of 20° C. Viscosity is herein measured by using a rheometer (PHYSICA MCR300, commercially available from Paar Physica Company). Furthermore, the recording liquid preferably has a surface tension that is in the range from 20 to 45 mN/m. Surface tension is herein measured by using a common surface tensiometer.

### Printing Method

A fourth embodiment of the invention provides a printing method. In the printing method, the ink composition is applied onto a printing medium, and then the resultant product is irradiated with ultraviolet light, thereby producing a printed article. By virtue of the printing method of the embodiment, the ink composition (pigment ink) is sufficiently cured on an absorbable medium, thereby enabling high-speed printing.

### Printed Article

A fifth embodiment of the invention provides a printed article. The ink jet recording-targeted ink composition is applied onto a printing medium, and then the resultant product is irradiated with ultraviolet light, thereby producing the printed article. In the printed article of the embodiment, the ink composition (pigment ink) is sufficiently cured, and a printed image having sufficiently high print density is provided.

### EXAMPLES

Although embodiments of the invention will be more specifically described with reference to examples, embodiments of the invention are not limited to only the examples.

### Synthesis of Amphiphilic Block Copolymer and Preparation of Photopolymerizable Polymer Micelle

### Synthetic Example 1

### 1. Synthesis of Polyethylene Glycol Atom Transfer Radical Polymerization (ATRP) Macroinitiator

Poly(ethylene glycol)monomethyl ether (number average molecular weight of 2000) of 10 g (0.005 mol) and triethylamine of 1.0 g (0.01 mol) were dissolved into anhydrous tetrahydrofuran (THF) of 70 mL. The resultant solution was slightly cooled in an ice bath, and 2-bromoisobutyryl bromide of 4.3 mL (0.035 mol) was slowly added to the resultant product. Then, the solution was warmed to room temperature and was then agitated for 24 hours. The resultant mixed solution was added to water, and then the resultant product was subjected to an extraction process by using methylene chloride. The produced extract was washed by using a hydrochloric acid solution of 1 mol/L and a sodium hydroxide solution of 1 mol/L in sequence. Subsequently, the resultant product was dried on magnesium sulfate, and then a solvent was removed under reduced pressure. The resultant crud product was dissolved in methylene chloride of minimum amount in which the crude product can be dissolved. Then, diethyl ether was added to the resultant product to generate precipitation, and then the precipitate was filtrated to obtain a white solid.

### 2. Synthesis of Poly(ethylene glycol)-poly(benzyl methacrylate-co-glycidyl methacrylate)

N,N,N′,N′,N″,N″-pentamethyldiethylenetriamine of 1.1 equivalents, copper (I) bromide of 1.1 equivalents, benzyl methacrylate of 5 equivalents, and glycidyl methacrylate of 5 equivalents were dissolved into THF. The polyethylene glycol ATRP macroinitiator of 1 equivalent was added to the resultant solution. The resultant product was subjected to a degassing process by using argon gas at room temperature for a time period that was in the range from 15 to 20 minutes. Subsequently, the resultant product was heated at a temperature of 60° C. for eight hours. Then, the resultant product was added to THF containing 10% methanol. A precipitated polymer was filtrated on silica gel, thereby removing copper bromide. Furthermore, the produced polymer was dialyzed against water for 48 hours and was then freeze-dried.

### 3. Synthesis of Poly(ethylene glycol)-poly(benzyl methacrylate-co-acryloylated glycidyl methacrylate)

Poly(ethylene glycol)-poly(benzyl methacrylate-co-glycidyl methacrylate) of 11 equivalents was dissolved into methyl ethyl ketone. Acrylic acid of five equivalents was added to the resultant solution. Then, tetrabutylammonium chloride of 5000 ppm and hydroquinone monomethyl ether of 2000 ppm were added to the resultant product, and reaction was advanced at a temperature of 50° C. for 10 hours. After the reaction had been finished, the resultant product was washed with water, and then an evaporator was used to remove methyl ethyl ketone.

The produced composite was evaluated by using an infrared spectrophotometer (MAGNA-IR 860, commercially available from Nicolet Company), and it was found that the characteristic absorption of an epoxide group (1250 cm-1 and 950 to 800 cm-1) was vanished and that characteristic absorption of a vinyl group (810 cm-1) was present. Namely, it was confirmed that poly(ethylene glycol)-poly(benzyl methacrylate-co-acryloylated glycidyl methacrylate) was synthesized from poly(ethylene glycol)-poly(benzyl methacrylate-co-glycidyl methacrylate).

### 4. Preparation of Photopolymerizable Polymer Micelle

Poly(ethylene glycol)-poly(benzyl methacrylate-co-acryloylated glycidyl methacrylate) of 10 g and a photopolymerization initiator TPO of 0.5 g were added to water of 10 g, and the resultant product was heated to a temperature of 40° C. and was then mixed. Water of 40 g was gradually added to the resultant product, thereby preparing an amphiphilic block polymer emulsion in which the photopolymerization initiator was encapsulated, namely a phopolymerizable polymer micelle solution.

### 5. Photo-Curable Properties of Photopolymerizable Polymer Micelle

The photopolymerizable polymer micelle solution was applied onto a glass plate by using a bar coater so as to have a thickness of 10 μm. The resultant product was irradiated with energy of 300 mJ/cm² by using a light-emitting diode (LED) lamp with a wavelength of 395 nm. As a result, a cured article was produced in the presence of water.

### Synthetic Example 2

### 1. Synthesis of Polyethylene Glycol ATRP Macroinitiator

The same procedures as employed in the synthesis example 1 were similarly employed.

### 2. Synthesis of Poly(ethylene glycol)-poly(styrene-co-acrylic acid)

N,N,N′,N′,N″,N″-pentamethyldiethylenetriamine of 1.1 equivalents, copper (I) bromide of 1.1 equivalents, styrene of 5 equivalents, and acrylic acid of 5 equivalents were dissolved into THF. The polyethylene glycol ATRP macroinitiator of 1 equivalent was added to the resultant solution. The resultant product was subjected to a degassing process by using argon gas at room temperature for a time period that was in the range from 15 to 20 minutes. Subsequently, the resultant product was heated at a temperature of 60° C. for eight hours. Then, the resultant product was added to THF containing 10% methanol. A precipitated polymer was filtrated on silica gel, thereby removing copper bromide. Furthermore, the produced polymer was dialyzed against water for 48 hours and was then freeze-dried.

### 3. Synthesis of Poly(ethylene glycol)-poly(styrene-co-4-hydroxybutyl acrylate glycidyl ether modified acrylic acid)

Poly(ethylene glycol)-poly(styrene-co-acrylic acid) of 11 equivalents was dissolved into methyl ethyl ketone. To the resultant solution, 4-hydroxybutyl acrylate glycidyl ether (commercially available from Nippon Kasei Chemical Co., Ltd.) of five equivalents was added. Then, tetrabutylammonium chloride of 5000 ppm and hydroquinone monomethyl ether of 2000 ppm were added to the resultant product, and reaction was advanced at a temperature of 50° C. for 10 hours. After the reaction had been finished, the resultant product was washed with water, and then an evaporator was used to remove methyl ethyl ketone.

The produced composite was evaluated by using the above infrared spectrophotometer, and it was found that the characteristic absorption of an epoxide group (1250 cm⁻¹ and 950 to 800 cm⁻¹) was vanished and that characteristic absorption of a vinyl group (810 cm⁻¹) was present. Namely, it was confirmed that poly(ethylene glycol)-poly(styrene-co-4-hydroxybutyl acrylate glycidyl ether modified acrylic acid) was synthesized from poly(ethylene glycol)-poly(styrene-co-acrylic acid).

### 4. Preparation of Photopolymerizable Polymer Micelle

Poly(ethylene glycol)-poly(styrene-co-4-hydroxybutyl acrylate glycidyl ether modified acrylic acid) of 10 g and a photopolymerization initiator TPO of 0.5 g were added to water of 10 g, and the resultant product was heated to a temperature of 40° C. and was then mixed. Water of 40 g was gradually added to the resultant product, thereby preparing an amphiphilic block polymer emulsion in which the photopolymerization initiator was encapsulated, namely a photopolymerizable polymer micelle solution.

### 5. Photo-Curable Properties of Photopolymerizable Polymer Micelle

The photopolymerizable polymer micelle solution was applied onto a glass plate by using a bar coater so as to have a thickness of 10 μm. The resultant product was irradiated with energy of 300 mJ/cm² by using a light-emitting diode (LED) lamp with a wavelength of 395 nm. As a result, a cured article was produced in the presence of water.

Embodiments of the invention can be industrially applied to an ink jet recording-targeted ultraviolet curable recording liquid, an ink jet recording method, and an ink jet recorded article, each being especially preferable for use in high-speed printing in which an absorbable medium such as actual printing paper, fine paper, or plain paper is used. Furthermore, embodiments of the invention can be also industrially applied to an ink jet recording-targeted ultraviolet curable recording liquid, an ink jet recording method, and an ink jet recorded article, each enabling a high-quality printed article to be provided, and the high-quality printed article having excellent adhering properties (fixing properties) with respect to a recording medium such as a metallic, ceramic, or plastic material.

What is claimed is:

1. A photopolymerizable polymer micelle comprising:
a spherical micelle that encapsulates a hydrophobic photopolymerization initiator, the spherical micelle being formed by a block copolymer having a hydrophilic block segment and a hydrophobic block segment, the block copolymer having a number average molecular weight exceeding 10000, and the hydrophobic block segment at least partially having a radically polymerizable group.

2. The photopolymerizable polymer micelle according to claim 1, wherein
a (a) block copolymer has a hydrophobic block segment into which a radically polymerizable group is introduced and has a hydrophilic block segment having a hydrophilic group, each being aligned in this order,
a (b) block copolymer has a hydrophobic block segment into which a radically polymerizable group is introduced, a hydrophobic block segment having a hydrophobic group, and a hydrophilic block segment having a hydrophilic group, each being aligned in this order, and
any one of the (a) block copolymer and the (b) block copolymer forms a micelle structure in an aqueous solvent primarily containing water, wherein
in the micelle structure, the hydrophobic block segment having the radically polymerizable group is oriented at the core side, and
the hydrophilic block segment having the hydrophilic group is oriented at the side of the aqueous solvent.

3. The photopolymerizable polymer micelle according to claim 1, wherein
the hydrophilic block segment has one or more groups selected from the group consisting of a polyethylene oxide group, a carboxylate group, a sulfonate group, a phosphinic acid group, an amide group, and a hydroxyl group, and
the hydrophobic block segment has one or more groups selected from the group consisting of an aliphatic hydrocarbon group, an aromatic hydrocarbon group, an alicyclic hydrocarbon group, a fluoroalkyl group, and a polysiloxane group and has a group having the radically polymerizable group at its terminal.

4. The photopolymerizable polymer micelle according to claim 1, wherein
the radically polymerizable group is one or more groups selected from the group consisting of an acryloyl group, a methacryloyl group, a vinyl group, and a vinyl ether group.

5. The photopolymerizable polymer micelle according to claim 1, wherein
the hydrophobic photopolymerization initiator absorbs light that is in a wavelength range from 380 to 420 nm.

6. A method of producing a photopolymerizable polymer micelle: the method comprising
a first process of producing a solution in which a block copolymer is dissolved in water, the block copolymer having a hydrophilic block segment and a hydrophobic block segment and having a number average molecular weight exceeding 20000, and the hydrophobic block segment at least partially having a radically polymerizable group;
a second process of forming a mixed solution as a result of adding a hydrophobic photopolymerization initiator to the solution and then being mixed; and
a third process of forming a micelle as a result of further adding water to the mixed solution for emulsification, the micelle being formed by the block copolymer and encapsulating the hydrophobic photopolymerization initiator.

7. A recording liquid containing the photopolymerizable polymer micelle according to claim 1.

8. A recording liquid containing the photopolymerizable polymer micelle according to claim 2.

9. A recording liquid containing the photopolymerizable polymer micelle according to claim 3.

10. A recording liquid containing the photopolymerizable polymer micelle according to claim 4.

11. A recording liquid containing the photopolymerizable polymer micelle according to claim 5.
